(19) United States
(12) Patent Application Publication
(10) Pub. No.: US 2007/0287417 A1
(43) Pub. Date: Dec. 13, 2007

(54) Mobile Network Security System

(76) Inventor: Aviv Abramovich, Ramat Gan (IL)

Correspondence Address: Mark M Friedman;c/o Polkinghorn, 9003 Florin Way, Upper Marlboro, MD, 20772, US

(21) Appl. No.: 10/579,405

(22) PCT Filed:
(86) PCT No.: PCT/IL04/00942

Related U.S. Application Data
(60) Provisional application No. 60/544,333, filed on Feb. 17, 2004.

(51) Int. Cl. H04M 1/66

(52) U.S. Cl. 455/410

(57) ABSTRACT

A method for providing security in a mobile data network including a serving node, serving mobile stations and undergoing data communications with a gateway node, the data communications transferring data contained in data packets encapsulated in a tunnel by the serving node and the gateway node, each data packet including a payload and a reference to a protocol context, the protocol context including identifiers for each of the mobile stations using the tunnel, the method includes a mobile network security system. The mobile network security system monitors the creation, updating and destruction of the tunnel and reads the reference to the protocol context of the data packets; and selects a policy based on a tunnel profile that performs an action to the data packets. The action is preferably based on the payload.

### FIELD AND BACKGROUND OF THE INVENTION

The present invention relates to cellular network technology and, more particularly, to a system and method to provide security to mobile data communications networks.

During the last twenty years communications network technology has undergone two major trends. One trend has been a revolutionary increase in data communications, and particular in data communications in networks based on Internet protocol (IP). The second major trend has been a dramatic increase in the use of mobile telephone networks including cellular networks and mobile personal communications networks. Several competing technologies and standards have arisen for cellular mobile communications. Like wired telephone service, (sometimes known as POTS, “plain old telephone service”), first and second generation mobile communications networks are circuit switched, ie. a circuit or channel is open during the time of a conversation and the open circuit is closed at the end of a conversation. Data networks, such as those based on IP protocol are packet switched. Data is divided into packets, each packet includes a header with an address and routing of the data packets through the network is based on the address contained in the header.

Circuit switched networks while appropriate for voice communications in both wired and mobile telephone networks, are not appropriate for the efficient transport of data. Therefore, there has been considerable effort during the past several years to incorporate packet switched data communications within the infrastructure of existing mobile telephone technologies. One such development is known as “Global Packet Radio Services” (GPRS) being developed for the cellular network standard known as GSM, “Global System for Mobile Communications”.

GPRS is an emerging standard for generation 2+ GSM cellular networks and is also an essential step towards third generation mobile network (UMTS) that are entirely packet switched, including voice channels being carried over IP. GPRS provides an efficient usage of the GSM radio interface because a number of mobile telephones can share a single radio channel. A simplified drawing of a GPRS network 10 is shown in FIG. 1. Referring now to FIG. 1, a mobile station 101 is in duplex wireless communication with a base transceiver station (BTS) 103. Typically, a group of base transceiver stations (BTS) 103 is controlled by a single base station controller (BSC) 104. Both base transceiver station (BTS) 103 and base station controller (BSC) 104 handle both conventional circuit switched communications, e.g. voice, as well as packet switch data communications. For circuit switched communications, base station controller (BSC) 104 provides a channel to a mobile switching center (not shown). For packet switch data communications, GPRS network 10 includes several network elements known as GPRS support nodes (GSN). Specifically, a serving GSN (SGSN) 105 is connected to base station controller (BSC) 104. SGSN 105 forwards incoming and outgoing IP packets addressed to and from mobile station 101 that is attached within the control area of SGSN 105. SGSN 105 also provides packet routing transfer outside the control area of SGSN 105. SGSN 105 also provides ciphering and authentication, session management, mobility management and logical link management to mobile station 101. SGSN 105 is connected to a gateway GPRS support node (GGSN) 111, a second primary component in GPRS network 10, through a GPRS backbone 107. Gateway GPRS support node (GGSN) 111 is connected to and provides an interface to an external IP network 113. GGSN 111 acts as a router for the IP addresses of all subscribers served through GPRS backbone 107. A border gateway 117 provides an interface to a public land mobile network (PLMN) 109. Typically, PLMN 109 is a mobile network of a different operator. Connections between different mobile networks enable roaming between different geographic regions.

When a user of mobile station 101 initiates a connection to the Internet, SGSN 105 registers mobile station 101 by assigning a “context” to mobile station 101. In GPRS network 10, the context is known as GPRS packet data protocol (PDP) context and includes a number of parameters. Some parameters are identifiers, including IMSI (International Mobile Subscriber Identity) a unique number assigned to each GPRS subscriber, an access point name (APN) and the phone number (MSISDN) of mobile station 101. The PDP context of mobile station 101 is periodically updated such as when mobile station is moved out of the routing area of SGSN 105 into a different routing area.

When mobile station 101 undergoes data communications, SGSN 105 uses the information contained in the PDP context of mobile station 101, and encapsulates each data packet sent from mobile station 101 with a reference to the PDP context. This technique is called “tunneling”. Each tunnel includes encapsulated data packets communicating to and from serving node 105 and gateway node 111. There can be several tunnels serving the same mobile station. When a tunnel is created a protocol context is negotiated between the two end points of the tunnel, serving node 105 and gateway node 111. The protocol context is communicated to and from serving node 105 and gateway node 111 with signaling packets. The content of the context is modified during the life of the tunnel and at the end of the tunnel the context is destroyed by both sides, each tunnel data packet including a payload, a data packet that is coming to or from the mobile station, and a reference to a protocol context, the protocol context includes a plurality of identifiers for the mobile station using the tunnel. The original data packet, known as the “payload” remains encapsulated throughout the tunnel. At the end of the tunnel GGSN 111, for instance, removes the payload, e.g. IP packet, and transfers the data as an IP packet to external IP network 113. The tunneling protocol used between SGSN 105 and GGSN 111 is known as GPRS tunneling protocol (GTP). The use of GTP allows packets different protocols, e.g. HTTP, DNS queries, to be tunneled through GPRS backbone 107 with different types of traffic from mobile stations 101. GTP is implemented only by GPRS support nodes SGSN 105 and GGSN 111. Other systems are unaware of GTP.

There are many potential security threats in a mobile data network such as GPRS. Security threats include eavesdropping, masquerading, traffic analysis, manipulation and denial of service. An attacker can potentially break into a mobile data network from external IP network 113 or from external mobile network PLMN 109. Mobile data networks are more difficult to secure than fixed data networks, In fixed data networks, there is generally a single entry point between an internal corporate network and the external network. Generally, users are trusted within the internal local area network. In contrast, mobile users even of the same mobile network are not trusted users

An operator of a mobile data network can protect GPRS backbone 107 from some potential attacks originating in external IP network 113, with a conventional system such as a firewall or an intrusion detection system at data and signal interface 115 between GGSN 111 and external IP network 113. However, GPRS backbone 107 is vulnerable to attack particularly from PLMN 109 especially when a competing operator is running PLMN 109. At entry point to border gateway 117, conventional security systems, e.g. firewall or intrusion detection systems are not appropriate for securing mobile stations in a mobile data network because conventional security systems are unaware of a tunneling protocol in use.

Prior art methods and systems for providing security in a mobile data network include Check Point® FireWall-1 GX Version 2.5 and Netscreen® 500-GPRS (Juniper Networks Inc., Sunnyvale, Calif.). “Check Point® FireWall-1 GX User Guide, Version 2.5” is incorporated for all purposes by reference as if fully set forth herein.

Reference is now made to FIG. 2a, a simplified drawing of a prior art security system 200, e.g. Check Point® FireWall-1 GX ver 2.5. Security system 200a is connected “in-line” between GPRS backbone 107 and public land mobile network (PLMN) 109. Security system 200a further includes a gateway interface 203, a signal and data interface connected to border gateway 117 and operatively connected to gateway nodes, e.g. GGSN (not shown) in PLMN 109. Security system 200a further includes a serving interface 205, operatively connected to serving nodes 105, e.g. SGSN. Similarly, Security system 200b is located between local GGSN 111 and GPRS backbone 107. Security system 200c is located between SGSN 105 and the GPRS backbone 107. Secure mobile data network further includes a conventional firewall 207 at the entry point to external IP network 113.

Prior art security system 200 operates by monitoring the signal packets communicated between serving node 105 and gateway node 111. Prior art security system 200 further reads the reference to the protocol context in each data packet. Security system 200 verifies for instance that the data packet has a valid protocol context. Security system 200 can further apply a firewall policy, quality of service (QoS) and or apply a virtual private network (VPN) based on identifiers included in the protocol context. However, prior art system 200 does not provide a security policy based on the payload carried in the data packets. On the other hand firewall 207 is used to apply a security policy on for instance IP packets, i.e. the payload of data packets in the mobile network, however, firewall 207 is unaware of the protocol context and therefore firewall 207 cannot apply for instance a security policy based on the telephone number of the mobile station.

There is thus a need for, and it would be highly advantageous to have a system and method to provide security to mobile users in mobile data communications networks; a system and method that applies a security policy based on both the protocol context and the payload of data packets encapsulated in a tunnel.

### SUMMARY OF THE INVENTION

According to the teachings of the present invention, the method includes capturing the protocol context of tunneled data packets and relating the tunneled data packets to an appropriate stored tunnel context and assigning an appropriate tunnel profile for the tunnel context. The tunnel profile is then used to apply, based on the tunnel profile: security checking, bandwidth management, quality of service, virtual private network, intrusion detection and prevention, and/or voice over Internet protocol.

According to the present invention there is provided a method for providing security in a mobile data network. The mobile data network includes a serving node, serving a plurality of mobile stations and undergoing data communications with a gateway node. The data communications transfer data contained in data packets encapsulated in a tunnel by the serving node and gateway node. Each data packet includes a payload and a reference to a protocol context. The protocol context includes identifiers for each of the mobile stations using the tunnel. The serving node and the gateway node further communicate with each other using signaling packets for the creation, updating and destruction of the tunnel. The protocol context of the tunnel is communicated by the signaling packets. The method includes (a) providing a mobile network security system including a serving interface operatively connected to the serving node, a gateway interface operatively connected to the gateway node, a processor and a memory. The data packets and the signal packets pass through the serving interface and the gateway interface. The mobile network security system monitors the creation, updating and destruction of the tunnel by monitoring the signal packets. The method further includes (b) reading by the processor the reference to the protocol context of one or more data packets; and (c) applying a policy based on a tunnel profile, thereby performing an action to the data packets, wherein the action is based on the payload. The tunnel profile is selected based on the identifiers carried in the protocol context. Preferably, the method includes prior to applying a policy, (d) storing in the memory a tunnel context based on the protocol context, wherein the tunnel context includes the identifiers. Preferably, prior to applying a policy, the tunnel profile is stored in the memory. Preferably, the identifiers include an access point name, a user name and a telephone number for each of the mobile stations. Preferably, the tunnel context is updated upon a change in the protocol context and the modified tunnel context is stored. Preferably the tunnel profile is updated based on the modified tunnel context and further based on information from an external database. Preferably, the external database is included in an external system such as fraud management systems, charge and billing systems, account management and/or authentication servers. Preferably, applying a policy provides a service such as security checking, bandwidth management, quality of service, virtual private network, extended security checking, intrusion detection and prevention, and voice over Internet protocol, wherein said service is selected based on said tunnel profile, and the service is selected based on the tunnel profile. Preferably, the service is differentiated respectively to each of the mobile stations based on the tunnel profile.

According to the present invention there is provided a method for providing security in a mobile data network. The network includes a serving node that serves mobile stations and undergoes data communications with a gateway node. The data communications transfer data contained in data packets encapsulated in a tunnel by the serving node and the gateway node. Each data packet includes a payload and a reference to a protocol context for each of the mobile stations using the tunnel. The serving node and gateway node further communicate with each other using signaling packets for the creation, updating and destruction of the tunnel. The protocol context of the tunnel is communicated by the signaling packets. The method includes (a) providing a mobile network security system. The mobile network security system includes an interface to the mobile data network, a processor and a memory. The mobile network security system monitors the creation, updating and destruction of the tunnel by monitoring the signal packets. The method further includes reading by the processor the reference to the protocol context; and (c) querying by a management system for information stored in the protocol context.

According to the present invention there is provided a method for providing security in a mobile data network including a serving node serving a plurality of mobile stations and undergoing data communications with a gateway node. The data communications transfer data contained in data packets encapsulated in a tunnel by the serving node and gateway node. Each data packet includes a payload and a reference to a protocol context. The protocol context includes a plurality of identifiers for each of the mobile stations using the tunnel. The serving node and gateway node further communicate with each other using signaling packets for the creation, updating and destruction of the tunnel. The protocol context of the tunnel is communicated by the signaling packets. The method includes (a) providing a mobile network security system. The system includes an interface to the mobile data network, a processor and a memory. The mobile network security system monitors the creation, updating and destruction of the tunnel by monitoring the signal packets. The method further includes (b) reading by the processor the reference to the protocol context; and (c) sending commands to destroy the data packets of the tunnel when the tunnel is in use by an unauthorized mobile station. The data packets are identified based on the protocol context.

According to the present invention there is provided a system that provides security in a mobile data network. The network includes a serving node, serving a plurality of mobile stations and undergoing data communications with a gateway node. The data communications transfer data contained in data packets encapsulated in a tunnel by the serving node and gateway node. Each data packet includes a payload and a reference to a protocol context. The protocol context includes a plurality of identifiers for each of the mobile stations using the tunnel. The serving node and the gateway node further communicate with each other using signaling packets for the creation, updating and destruction of the tunnel. The protocol context of the tunnel is communicated by the signaling packets, the system includes a serving interface operatively connected to the serving node; (b) a gateway interface operatively connected to the gateway node; wherein the data packets and signaling packets pass through the serving interface and the gateway interface; (c) a processor which reads the reference to the protocol context of at least one of said data packets; and (d) a memory mechanism. The processor selects a policy based on a tunnel profile previously stored with the memory mechanism; the processor thereby performs an action to the data packets, wherein the action is based on the payload. The tunnel profile is selected based one or more identifiers carried in the protocol context. Preferably, the memory mechanism further stores a tunnel context based on the protocol context, wherein the tunnel context includes one or identifiers. Preferably, the system further includes (e) a management interface, operatively connected to a management system for querying information stored in the tunnel context. Preferably, the identifiers include an access point name, a user name and a telephone number of the mobile station. Preferably, the processor updates the tunnel context based on a change of the protocol context, and thereby stores with the memory mechanism a modified tunnel context, and the processor updates the tunnel profile based on the modified tunnel context. Preferably, the processor updates the tunnel context based on the mobile station roaming to a second serving node. Preferably, the processor destroys a tunnel context by commanding a serving node or a gateway node to destroy the tunnel. Preferably, the system further includes an external database, wherein the tunnel profile is further based on information from the external data base. Preferably, the external database is included in an external system such as fraud management systems, charge and billing systems, account management systems and authentication servers. Preferably, the policy provides a service including security checking, bandwidth management, quality of service, virtual private network, extended security checking, intrusion detection and prevention and voice over Internet protocol. The service is selected based on the tunnel profile; wherein the service is differentiated respectively to each of the mobile stations based on the tunnel profiles.

According to the present invention there is provided a method for providing security during roaming and handoff from a first mobile data network to a second mobile data network. Each network includes a serving node, serving a plurality of mobile stations and undergoing data communications with a gateway node. The data communications transfer data contained in data packets encapsulated in a tunnel by the serving node and gateway node. Each data packet includes a payload and a reference to a protocol context. The protocol context includes identifiers for each of the mobile stations using the tunnel. The serving node and gateway node further communicate with each other using a plurality of signaling packets for the creation, updating and destruction of the tunnel. The protocol context of the tunnel is communicated by the signaling packets. The method includes (a) providing a first mobile network security system to the first mobile data network and further providing a second mobile network security system to the second mobile data network, each security system includes a serving interface operatively connected to the serving node, a gateway interface operatively connected to the gateway node, a processor and a memory. The data packets and the signal packets pass through the serving interface and the gateway interface, wherein the first and second mobile network security system monitor the creation, updating and destruction of the tunnel by monitoring the signal packets. The method further includes (b) reading the reference to the protocol context of at least one of the data packets by the processor of the first mobile security system; and (c) storing a tunnel context based on the protocol context in the memory of the first mobile security system, wherein the tunnel context includes the identifiers; and (d) transferring the tunnel context to the second mobile network security system thereby protecting the second mobile data network wherein the mobile station associated with the tunnel context roams to the second mobile data network. Preferably, transferring the tunnel context occurs prior to the hand-off from the first mobile data network to the second mobile data network.

According to the present invention there is provided, a method for providing security in a mobile data network including a serving node, serving a plurality of mobile stations and undergoing data communications with a gateway node. The data communications transfer data contained in data packets encapsulated in a tunnel by the serving node and gateway node. Each data packet includes a payload and a reference to a protocol context; the protocol context includes identifiers for each of the mobile stations using the tunnel. The serving node and gateway node further communicate with each other using signaling packets for the creation, updating and destruction of the tunnel. The protocol context of the tunnel is communicated by the signaling packets, the method includes (a) providing a mobile network security system including an interface to the mobile data network, a processor and a memory, The mobile network security system monitors the creation, updating and destruction of the tunnel by monitoring the signal packets. The method further includes (b) reading by the processor the reference to the protocol context and the payload of the data packets; and (c) applying a policy, thereby performing an action the data packets, wherein the action is based on the payload, and is selected based on one or more identifiers carried in the protocol context.

According to the present invention there is provided a program storage device readable by a machine tangibly embodying a program of instructions executable by the machine for implementing the methods of the present invention described herein.

### BRIEF DESCRIPTION OF THE DRAWINGS

The invention is herein described, by way of example only, with reference to the accompanying drawings, wherein:

FIG. 1 is a drawing of a prior art mobile data network;

FIG. 2a is a simplified schematic drawing of a mobile data network with a prior art security system according to an embodiment of the present invention;

FIG. 2b is a simplified schematic drawing of a mobile data network with a security system according to an embodiment of the present invention;

FIG. 3 is a simplified flow diagram of a system and method for securing mobile data networks, the method according an embodiment of the present invention;

FIG. 4 is a simplified flow diagram of a method for securing mobile data networks, the method according to an embodiment of the present invention;

FIG. 5 is a simplified schematic diagram showing a security system integrated with mobility management, according to an embodiment of the present invention.

### DESCRIPTION OF THE PREFERRED EMBODIMENTS

The present invention is of a system and method for providing security to mobile data communications networks. Specifically, the present invention provides security enforcement while the mobile traffic payload is still encapsulated allowing applying different policies for different contexts based on the payload.

The present invention is used to provide security between and within mobile data communications networks and between mobile data communications networks operated by different operators by applying a security policy based on protocol context and the encapsulated payload. The present invention also provides additional security from attacks from a wired network, e.g. Internet, since a traditional firewall is not equipped to prevent attacks on mobile users. The present invention is used to grade the networking service that a mobile station receives e.g. quality of service (QoS), virtual private network (VPN), extra security services, voice over IP (VoIP) or to limit the usage of certain network protocols by some users.

The principles and operation of a system and method for providing security to mobile data communications networks, according to the present invention may be better understood with reference to the drawings and the accompanying description.

The discussion herein relates primarily to a system configured “in-line” that opens data packets encapsulated in a tunnel, subsequently reconstructs the data packets and sends them to their respective destinations. Although the discussion herein related primarily to an “in-line” system the present invention may, by non-limiting example, alternatively or additionally be configured in a “sniffing mode”, i.e. copying and opening data packets and sending requests, for instance to block a mobile user, to the serving nodes 105 and gateway nodes 111 without directly mediating the communications between the serving nodes 105 and gateway nodes 111. Alternatively, according to some embodiments the method of the present invention is performed with multiple systems 201. For instance one or more systems 201 function to capture the protocol context e.g. from signaling packets and other systems 201 use the context to apply a specific policy.

Before explaining embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

By way of introduction, principal intentions of the present invention are to: (1) provide security to mobile stations undergoing data communications in a mobile data network including security against attacks emanating from mobile stations (2) grade the networking service that a mobile station receives (3) provide security to a mobile data network from a competing operator or mobile users of a competing operator of another mobile data network, (4) maintain security or level of service while a mobile station roams from one serving node to another serving node or to another mobile network and (5) base security on information from external systems, e.g. fraud management systems, account management systems, charge and billing systems, operating in coordination with a mobile data network. It should be noted that while the discussion herein is directed to public mobile cellular networks, particularly a GPRS network over a GSM mobile cellular network; the principles of the present invention may be adapted for use in, and provide benefit data communications over mobile cellular networks based on other technologies and standards such as CDMA, e.g. IS-95 or TDMA, e.g, IS-136. Furthermore, the principles of the present invention may be adapted for use in other wireless data networks, for example local wireless data networks based on IEEE 802.1x, known as “Wi-fi”; or for any tunneling protocol in which each tunnel carries packets of one user or users and in which the context of the tunnel is negotiated separately or as a preamble/header to the tunnel and in which an intermediate device can read from the context being negotiated one or more fields that can identity the user or users. The term “firewall policy” is defined as a stateful inspection of the payload of a data packet according to a predefined set of rules. The term “policy” is used herein to refer to any type of differentiated service provided to mobile users such as a security policy, or a subscriber level policy. The term “processor” as used herein refers also to any “device” capable of performing the method described, including but not limited to custom manufactured with for instance ASIC technology. The term “user” includes any entity including a person or application undergoing communication.

The present invention provides two levels of policy: (a) a “context sensitive policy” in which the creation/update/deletion of a protocol context is allowed based on identifiers of the protocol context, e.g. IMSI, MSISDN and/or APN; and (b) a “subscriber level policy”, applying a policy based on the payload of the mobile traffic. The following is an example of applying a subscriber level policy, according to the teachings of the present invention. Two mobile users Alice and Bob are subscribers of the Cellavie cellular operator. Alice paid for a full set of Internet connectivity access that allows access to the Internet with every available protocol (e.g., WAP, HTTP, SMTP, POP3, FTP, TELNET) Bob on the other hand bought access only for the WAP protocol. The Cellavie security department is required to enforce that Bob will be allowed to access only via WAP while Alice will be allowed unlimited access. According to an embodiment of the present invention, the following rules are used:

| | |
|---|---|
| 1. | source = Cellavie SGSN, destination = Cellavie GGSN, |
| | (IMSI = Alice or IMSI = Bob) -> action = accept |
| 2. | source = *, destination = *, protocol = *, Context =Alice |
| | -> action = accept |
| 3. | source = *, destination = *, protocol = WAP, Context =Bob |
| | -> action = accept |
| 4. | drop everything else |

Rule 1 is based on protocol context and allows both Alice and Bob access with the GPRS system. Rules 2 and 3 discriminate the mobile traffic based on the payload protocol. Rule 2 applies only for traffic from Alice while rule 3 applies only to traffic from Bob. Rule 4 drops any network traffic that did not match any of the previous rules.

Since applying a different policy to each and every mobile subscriber is virtually impossible the present invention introduces a new concept called a profile. A profile identifies a group of users requesting a service from the system. For example, lets assume that Bob and many other subscribers bought a connectivity package called “Internet with WAP” and Alice and many others bought a connectivity package called “Internet Unlimited”. During the context creation from Alice, Bob and any other mobile subscriber for that matter, the context is associated with a profile “Internet with WAP profile” or “Internet Unlimited Profile” based on the subscriber connectivity package. The definition of profiles allows re-writing rule 2 and 3 above as follows:

| | |
|---|---|
| 2. | source = *, destination = *, protocol = *, Context belongs to |
| | “Internet unlimited profile” -> action = accept |
| 3. | source = *, destination = *, protocol = WAP, Context belongs to |
| | “Internet with WAP profile” -> action = accept |

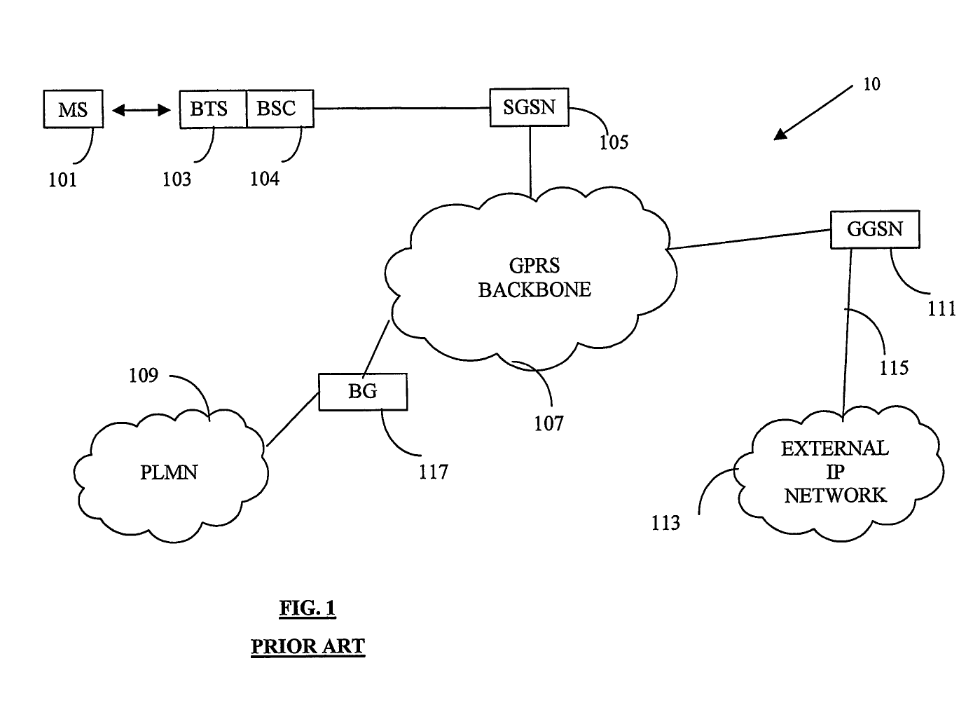

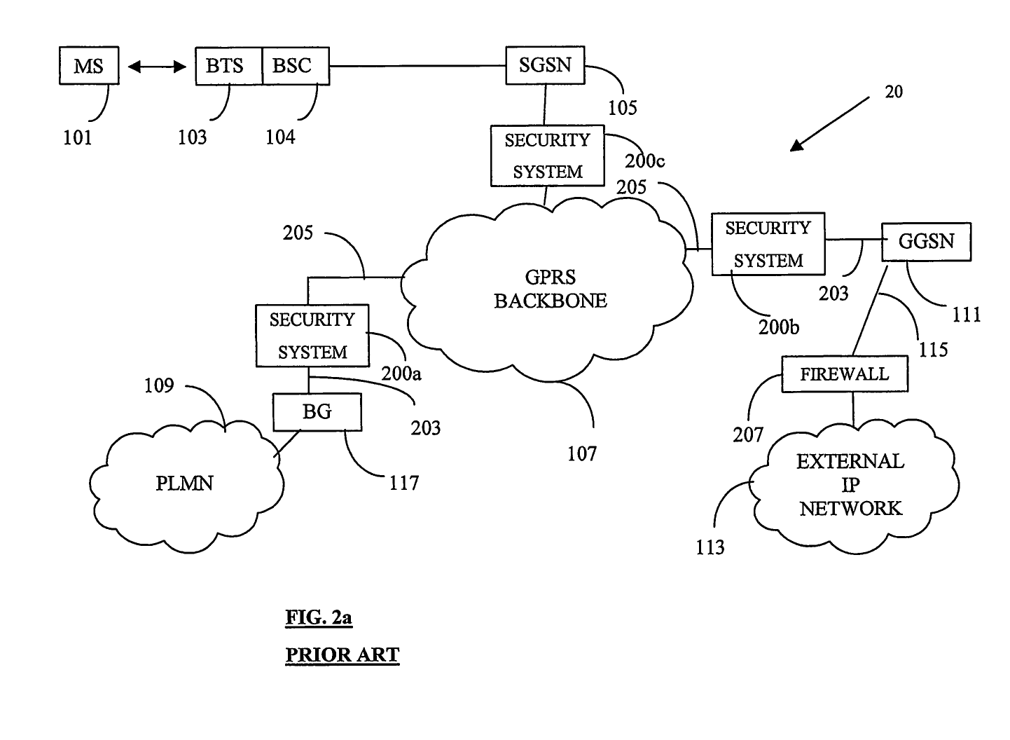

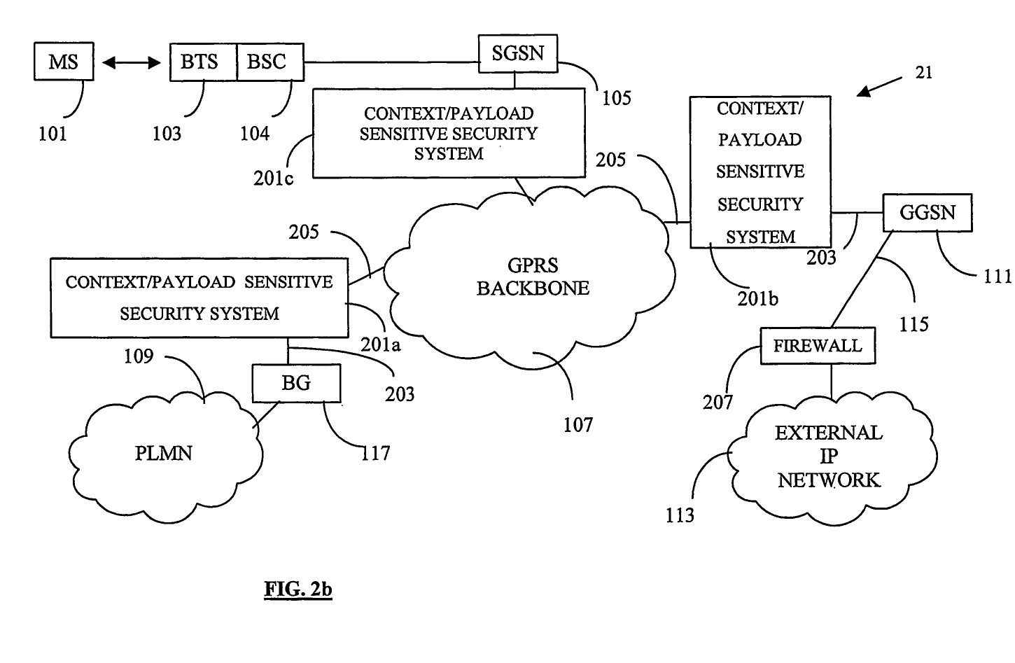

Referring now to the drawings, FIG. 2b illustrates a secure mobile data network 21, with context/payload sensitive security systems 201, according to an embodiment of the present invention, integrated into prior art mobile data network 10 as shown in FIG. 1. Specifically, security system 201a is connected “in-line” between GPRS backbone 107 and public land mobile network (PLMN) 109. Security system 201a further includes gateway interface 203, a signal and data interface connected to border gateway 117 and operatively connected to gateway nodes, e.g. GGSN (not shown) in PLMN 109. Security system 201a further includes a serving interface 205, operatively connected to serving nodes 105, e.g. SGSN. Secure mobile data network further includes conventional firewall 207 at the entry point to external IP network 113.

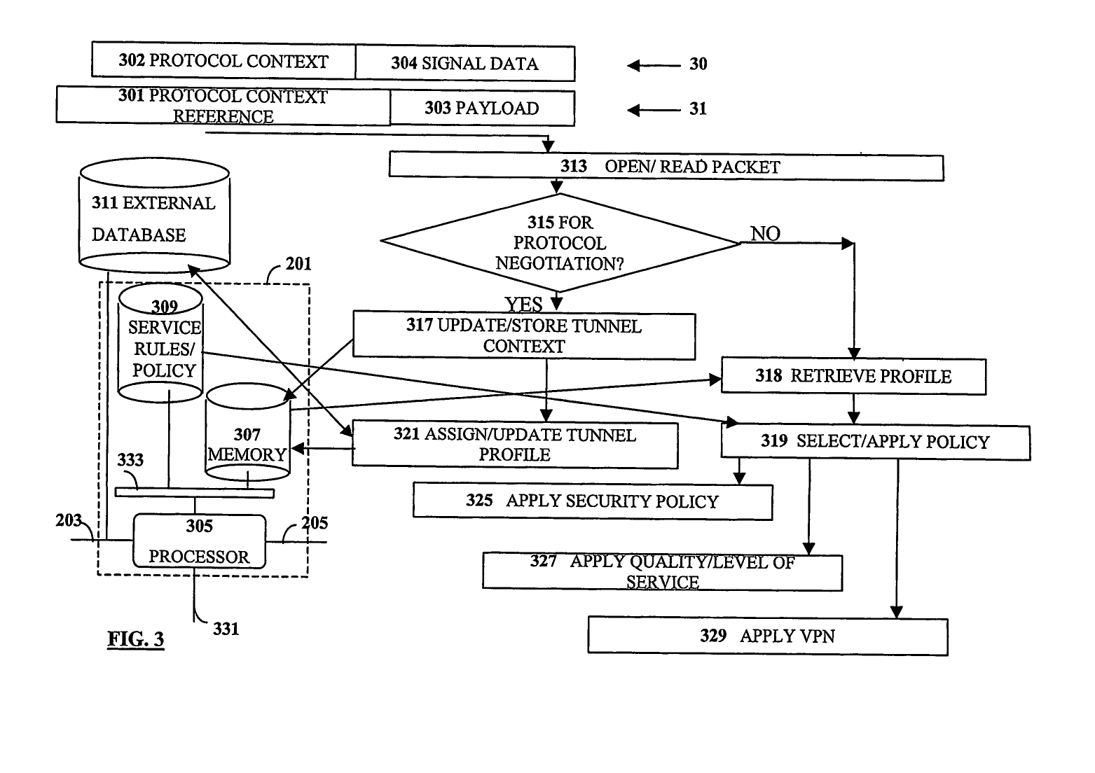

Reference is now made to FIG. 3 that illustrates a system and method providing security to mobile users in a mobile data network, according to an embodiment of the present invention. A signaling packet 30 is represented including at least in part a protocol context, e.g. GTP context 302. Signaling packet 30 may also include signaling data 304, used for instance for managing mobile roaming. An encapsulated data packet 31 is shown, including a reference 301 to protocol context 302, and a payload 303. Payload 303 is typically a data packet of standard protocol, e.g. UDP or TCP/IP used in wired data networks. Encapsulated data packet 31 or signaling packet 30 is opened (step 313) and the contents are read by processor 305. If the packet is used for protocol negotiation (decision block 315), e.g. including signaling packet 30, then a tunnel context is updated and stored (step 317) Typically the tunnel context includes identifiers in protocol context 302 such as an access point name (APN), a mobile station telephone number (MSISDN) and/or a user identity/SIM number (IMSI). One or more of these identifiers are stored (step 317) as a tunnel context in a local memory 307. A tunnel context is maintained for each mobile station 101 “attached” to secure mobile data network 21. If there is a change in protocol context 302, for instance because mobile station 101 has roamed to a different access point, the tunnel context for mobile station 101 is updated and subsequently stored (step 317) in memory 307. A processor 305 assigns (step 321) a tunnel profile to the tunnel context for each user/tunnel and stores the assigned tunnel profile in memory 307. Alternatively, either the tunnel context or the profile is stored in memory 307. Referring back to decision block 315, if the packet is data packet 31 then reference 301 to protocol context 302 is read by processor 305. Processor retrieves from memory 307, the tunnel profile associated with protocol context 302. Processor 305 then selects a policy (step 319) appropriate for the tunnel profile from service rule/policy storage 309 and applies (step 325, 327 and/or 329 depending on the policy selected. Referring back to our example, reference 301 referring to Alice is read by processor 305. “Internet Unlimited” profile is retrieved (step 318) from memory 307. An action “accept” is selected (step 319) to data packet 31.

Typically, in decision block 315, updating/storing (step 317) a tunnel context and/or assigning/updating (step 321) a profile are performed once for signal packet 30 and subsequently for each of data packets 30, from the same tunnel, the corresponding profile is retrieved (step 318) and the appropriate policy is selected (step 319) and applied (step 325, 327 and/or 329), i.e. action is taken.

At the end of data transmission, mobile station 101 for instance becomes inactive and the MSISDN is not available. The tunnel is consequently destroyed, the tunnel context and tunnel profile are optionally removed from memory 307. Optionally, commands are sent out by security system 201 to appropriate serving node 105 and/or gateway nodes 111 to destroy the tunnel. Commands are sent out to other security systems 201 to destroy all tunnels of mobile station 101. Other than applying (step 325) a security policy, the tunnel profile may specify other services such as applying (step 329) a virtual private network (VPN) or applying (step 327) a quality of service policy in addition (step 325) the security policy step my invoke additional security actions, i.e. extended security, e.g. anti-virus. Other applicable services (not shown) are intrusion detection and prevention, and Voice over Internet Protocol.

Security system 201 includes an interface to an external database 311. Database 311 preferably stores groups of identifiers of references to users, each group typically associated with a tunnel profile. For instance, external database 311 is associated with an external authentication server, e.g. RADIUS, which provides an identifier or otherwise a reference to each authenticated user.

Security system 201 includes a management interface 331 operatively connected to an external management system for querying stored information, e.g. tunnel context. Security system 201 further includes a memory mechanism 333, e.g. a memory bus for storing in memory 307 and service rule/policy storage 309.

For payload 303 of standard protocol, e.g. IP or IPv6, a policy of conventional firewall 207 is applied to payload 303. Optionally, different firewall policies are applied depending on the tunnel profile associated with encapsulating data packet 31.

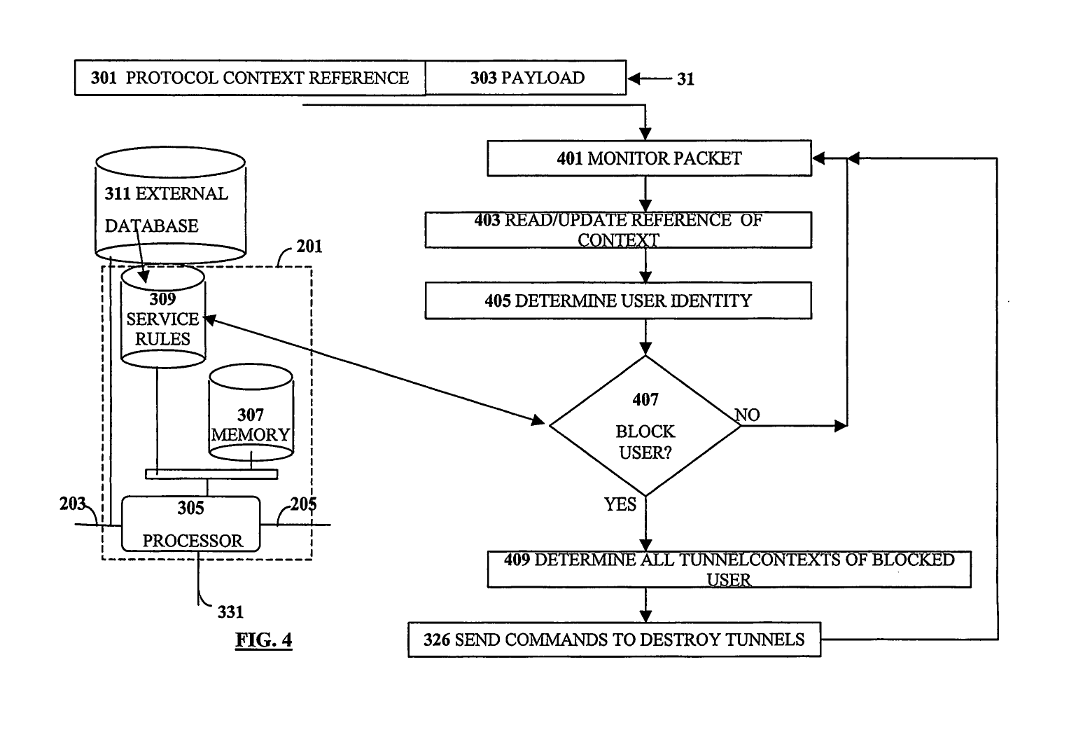

Reference is now made to FIG. 4, a flow diagram of a method, according to an embodiment of the present invention. Processor 305 monitors (step 401) incoming encapsulated data packet 31 incoming through either serving interface 203 or gateway interface 205. Processor 305 reads (step 403) reference 301 to protocol context 302 and determines (step 405) a user identity based on one or more identifiers in the stored tunnel context where the context was stored in the way described previously. Processor 305 compares the user identity with user identifiers in service rules sourced for instance in external database 311 associated with external fraud management systems, account management systems, charge and billing systems and/or authentication servers. If the user identity corresponds to an unauthorized user (decision block 407), processor 305 determines (step 409) all tunnel contexts associated with the unauthorized user. Security system 201 sends commands (step 325) optionally to other security systems 201, to serving nodes 105 and/or gateway nodes 111 to tear down all existing and future tunnels to block the unauthorized user.

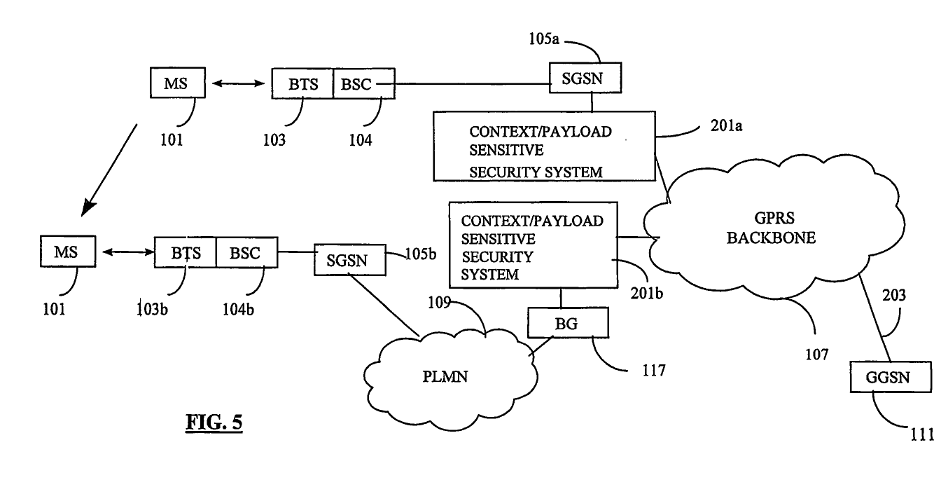

Reference is now made to FIG. 5. When a mobile station 101 roams from one network GPRS backbone 107 to another network PLMN 109, serving node 105a, connected to network 107 and serving node 105b connected to PLMN 109 negotiate the roaming using a mobility management protocol. Typically, the tunnel is transferred from serving node 105a to serving node 105b while maintaining the same gateway node 111. Security system 201a transfers the tunnel contexts used for mobile station 101 to security system 201b. Security system 201b allows data traffic only if the tunnel context corresponds to a tunnel context received from security system 201a. Security system 201 monitors the content of signaling packets prior to the actual handoff from serving node 105a to serving node 105b and is therefore aware that the handoff is imminent. Therefore context/payload sensitive security system 201 provides a higher level of security against for instance masquerading than prior art security system 200 that is only aware of the protocol context after the actual handoff has occurred.

With respect to the above description then, it is to be realized that the relationships for the parts of the invention include variations in function and manner of operation, assembly and use, are deemed readily apparent and obvious to one skilled in the art, and all equivalent relationships to those illustrated in the drawings and described in the specification are intended to be encompassed by the present invention. In particular the same invention can be applied to other tunneling protocols than GTP.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A method for providing security in a mobile data network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein at least a portion of the protocol context of the tunnel is communicated by at least one of the signaling packets, the method comprising the steps of:
(a) providing a mobile network security system including a serving interface operatively connected to the serving node, a gateway interface operatively connected to the gateway node, a processor and a memory,
wherein the data packets and the signal packets pass through said serving interface and said gateway interface, wherein said mobile network security system monitors the creation, updating and destruction of the tunnel by monitoring the signal packets;
(b) reading by said processor the reference to the protocol context of at least one of said data packets; and
(c) applying a policy based on a tunnel profile, thereby performing at least one action to said at least one of the data packets, wherein said at least one action is based on the payload, wherein said tunnel profile is selected based on at least one of the identifiers carried in the protocol context.

2. The method, according to claim 1, further comprising the step of, prior to said applying:
(d) storing in said memory a tunnel context based on the protocol context, wherein said tunnel context includes said at least one of the identifiers.

3. The method, according to claim 1, further comprising the steps of, prior to said applying:
(d) storing said tunnel profile in said memory.

4. The method, according to claim 1, wherein said at least one of the identifiers is selected from the group consisting of an access point name, a user name and a telephone number for each of the mobile stations.

5. The method, according to claim 2, further comprising the steps of:
(e) updating said tunnel context based on at least one change of the protocol context, and storing a modified tunnel context; and
(f) updating said tunnel profile based on said modified tunnel context.

6. The method, according to claim 1, wherein said tunnel profile is further based on information from an external data base.

7. The method, according to claim 6, wherein said external data base is included in an external system selected from the group consisting of fraud management systems, charge and billing systems, account management and authentication servers.

8. The method, according to claim 1, wherein said applying a policy provides a service selected from the group consisting of security checking, bandwidth management, quality of service, virtual private network, extended security checking, intrusion detection and prevention, and voice over Internet protocol, wherein said service is selected based on said tunnel profile.

9. The method, according to claim 8, wherein said service is differentiated respectively to each of the mobile stations based on said tunnel profile.

10. A method for providing security in a mobile data network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein at least a portion of the protocol context of the tunnel is communicated by at least one of the signaling packets, the method comprising the steps of:
(a) providing a mobile network security system including an interface to the mobile data network, a processor and a memory, wherein said mobile network security system monitors the creation, updating and destruction of the tunnel by monitoring the signal packets,
(b) reading by said processor the reference to the protocol context; and
(c) querying by a management system for information stored in the protocol context.

11. A method for providing security in a mobile data network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein at least a portion of the protocol context of the tunnel is communicated by at least one of the signaling packets, the method comprising the steps of:
(a) providing a mobile network security system including an interface to the mobile data network, a processor and a memory,
wherein said mobile network security system monitors the creation, updating and destruction of the tunnel by monitoring the signal packets,
(b) reading by said processor the reference to the protocol context; and
(c) sending commands to destroy the data packets of the tunnel wherein the tunnel is in use by an unauthorized mobile station, whereby the data packets are identified based on said protocol context.

12. A system which provides security in a mobile data network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein the protocol context of the tunnel is communicated by at least one of the signaling packets, the system comprising:
(a) a serving interface operatively connected to the serving node;
(b) a gateway interface operatively connected to the gateway node;
wherein the data packets and signaling packets pass through said serving interface and said gateway interface;
(c) a processor which reads the reference to the protocol context of at least one of said data packets; and
(d) a memory mechanism;
wherein said processor selects a policy based on a tunnel profile previously stored with said memory mechanism, said processor thereby performs at least one action to said at least one of the data packets, wherein said at least one action is based on the payload, wherein said tunnel profile is selected based on at least one of the identifiers carried in the protocol context.

13. The system, according to claim 12, wherein said memory mechanism further stores a tunnel context based on the protocol context, wherein said tunnel context includes said at least one of the identifiers.

14. The system, according to claim 12, further comprising:
(e) a management interface, operatively connected to a management system for querying information stored in the tunnel context.

15. The system, according to claim 12, wherein said at least one of the identifiers is selected from the group consisting of an access point name, a user name and a telephone number of said mobile station.

16. The system, according to claim 13, wherein said processor updates said tunnel context based on at least one change of the protocol context, and thereby stores with said memory mechanism a modified tunnel context, and said processor updates said tunnel profile based on said modified tunnel context.

17. The system, according to claim 13, wherein said processor updates said tunnel context based on the mobile station roaming to a second serving node.

18. The system, according to claim 13, wherein said processor destroys a tunnel context by commanding at least one node selected from the group consisting of serving nodes and gateway nodes to destroy the tunnel.

19. The system, according to claim 12, further comprising:
(e) an external database, wherein said tunnel profile is further based on information from said external data base.

20. The system, according to claim 19, wherein said external data base is included in an external system selected from the group consisting of fraud management systems, charge and billing systems, account management systems and authentication servers.

21. The system, according to claim 12, wherein said policy provides a service selected from the group consisting of security checking bandwidth management, quality of service, virtual private network, extended security checking, intrusion detection and prevention and voice over Internet protocol; wherein said service is selected based on said tunnel profile; wherein said service is differentiated respectively to each of the mobile stations based on said tunnel profiles.

22. A method for providing security during roaming and handoff from a first mobile data network to a second mobile data network, each network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein the protocol context of the tunnel is communicated by at least one of the signaling packets, the method comprising the steps of:
(a) providing a first mobile network security system to the first mobile data network and further providing a second mobile network security system to the second mobile data network, each security system including a serving interface operatively connected to the serving node, a gateway interface operatively connected to the gateway node, a processor and a memory,
wherein the data packets and the signal packets pass through said serving interface and said gateway interface, wherein said first and second mobile network security system monitor the creation, updating and destruction of the tunnel by monitoring the signal packets,
(b) reading the reference to the protocol context of at least one of said data packets by said processor of the first mobile security system; and
(c) storing a tunnel context based on the protocol context in said memory of the first mobile security system, wherein said tunnel context includes said at least one of the identifiers; and
(d) transferring said tunnel context to the second mobile network security system thereby protecting the second mobile data network wherein the mobile station associated with said tunnel context roams to the second mobile data network.

23. The method, according to claim 22, wherein said transferring said tunnel context occurs prior to the hand-off from the first mobile data network to the second mobile data network.

24. A method for providing security in a mobile data network including a serving node, serving a plurality of mobile stations and undergoing data communications with a gateway node, the data communications transferring data contained in a plurality of data packets encapsulated in a tunnel by the serving node and the gateway node, each data packet including a payload and a reference to a protocol context, the protocol context including a plurality of identifiers for each of the mobile stations using the tunnel, wherein the serving node and gateway node further communicate with each other using a plurality of signaling packets for the creation, updating and destruction of the tunnel, wherein at least a portion of the protocol context of the tunnel is communicated by at least one of the signaling packets, the method comprising the steps of:
(a) providing a mobile network security system including an interface to the mobile data network, a processor and a memory,
wherein said mobile network security system monitors the creation, updating and destruction of the tunnel by monitoring the signal packets,
(b) reading by said processor the reference to the protocol context and at least a portion of the payload of at least one of said data packets; and
(c) applying a policy, thereby performing at least one action to said at least one of the data packets, wherein said at least one action is based on the payload, wherein said at least one action is selected based on at least one of the identifiers carried in the protocol context.

25. A program storage device readable by a machine tangibly embodying a program of instructions executable by the machine for implementing the method of claim 1.

26. A program storage device readable by a machine tangibly embodying a program of instructions executable by the machine for implementing the method of claim 10.

27. A program storage device readable by a machine tangibly embodying a program of instructions executable by the machine for implementing the method of claim 11.

28. A program storage device readable by a machine tangibly embodying a program of instructions executable by the machine for implementing the method of claim 22.

29. A program storage device readable by a machine tangibly embodying a program of instructions executable by the machine for implementing the method of claim 24.
